(19) United States
(12) Patent Application Publication
(10) Pub. No.: US 2020/0130890 A1
(43) Pub. Date: Apr. 30, 2020

(54) NON-SPILL MEDICINE BOTTLE ATTACHMENT

(71) Applicants: Harinder Paul, Yuba City, CA (US); Parminder K. Gill, Yuba City, CA (US)

(72) Inventors: Harinder Paul, Yuba City, CA (US); Parminder K. Gill, Yuba City, CA (US)

(21) Appl. No.: 16/176,357

(22) Filed: Oct. 31, 2018

(51) Int. Cl. B65D 23/00; A61J 1/03

(52) U.S. Cl. CPC B65D 23/001; A61J 1/03

(57) ABSTRACT

A non-spill medicine bottle attachment is described herein. The attachment has a band, a base disposed on a bottom end of the band, and a writing surface disposed on an exterior surface of the band. The band can encircle a bottom portion of the medicine bottle such that the base is positioned at a bottom end of the medicine bottle to stabilize the medicine bottle in an upright or standing position. This stabilization can reduce spillage of medicine inside the bottle, especially when the bottle lid is not completely closed or secured.

### FIELD OF THE INVENTION

The present invention relates to accessories for medicine bottle, namely, an attachment for preventing a medicine bottle from spilling.

### BACKGROUND OF THE INVENTION

Medicine bottles are prone to falling and/or spilling because of its high aspect ratio, which makes the base of the bottle insufficiently wide as compared to the length, therefore it can easily lose balance. In addition, the lid and top opening of the bottle is typically larger than the base because of the locking mechanism that locks the lid in place, thereby making the bottle top-heavy and further contributing to the instability of the bottle. For example, the bottle may tip over and if the lid is not secured all the way or tight enough, the medicine can spill from the bottle. This may cause some medicine to be lost or disposed of due to contamination. Loss of medication may require additional costs for replacement, or the patient may have to skip some doses if the prescription has re-fill limitations. Moreover, the medicine bottle label is crowded with information typically written in small font sizes that make it difficult to read, particular for a patient with visual impairment. Thus, the bottles have the drawback of not clearly stating the relevant information, such as the medicine's purpose, the condition that is being treated, how many refills are left, when the next refill is due, and how often or times the medication needs to be taken.

Currently in the arts, U.S. Pat. No. 8,999,477 teaches an apparatus for attachment to a medicine container having a label with label surface and an attachment mechanism for attaching the label to a medicine container. MEDI RING® is another example of a labeling device featuring blank plastic adhesive labels. However, none of these devices stabilize the medicine bottle and can actually add weight to the upper portion of the bottle, thereby further destabilizing the bottle. Hence, there is a need for a more stable medicine bottle with improved labeling.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY OF THE INVENTION

The present invention features a non-spill medicine bottle attachment. In some aspects, the attachment may comprise a band configured to encircle a portion of the medicine bottle, a base disposed on a bottom end of the band, and a writing surface disposed on an exterior surface of the band. In some embodiments, the band can encircle a bottom portion of the medicine bottle such that the base is positioned at a bottom end of the medicine bottle to stabilize said medicine bottle.

One of the unique and inventive technical features of the present invention is the stabilizing base of the bottle attachment. Without wishing to limit the invention to any theory or mechanism, it is believed that this technical feature can advantageously reduce spillage of medicine inside the bottle, especially when the medicine container lid is not completely closed or secured. None of the presently known prior references or work has the unique inventive technical feature of the present invention.

Furthermore, the bottle attachment may be used to clearly label the contents of the bottle for a user. For example, the medication and purpose of the medication, e.g. blood pressure, heart, diabetes, cholesterol, etc., may be labeled on the writing surface of the attachment. The labeling may be conveniently written in the language most understood by the user so that the user can easily identify the medication. This feature can advantageously reduce the risk of selecting the wrong medication.

### BRIEF DESCRIPTION OF THE DRAWINGS

The features and advantages of the present invention will become apparent from a consideration of the following detailed description presented in connection with the accompanying drawings in which:

FIG. 1 shows one embodiment of the non-spill medicine bottle attachment of the present invention in use with a medicine bottle.

FIG. 2 shows an exploded view of the non-spill medicine bottle attachment in use with a medicine bottle.

FIGS. 3A-3I show various non-limiting embodiments of the non-spill medicine bottle attachment.

FIGS. 4A-4B show a top and bottom view, respectively, of one embodiment of the non-spill medicine bottle attachment.

FIGS. 4C-4D show a top and bottom view, respectively, of another embodiment of the non-spill medicine bottle attachment.

FIGS. 4E-4H show alternative embodiments of a top view of the non-spill medicine bottle attachment.

### DESCRIPTION OF PREFERRED EMBODIMENTS

Following is a list of elements corresponding to a particular element referred to herein:
10 medicine bottle
14 bottom end of the medicine bottle
18 outer diameter of the medicine bottle
100 system
105 non-spill medicine bottle attachment
110 band
112 bottom end of the band
114 top end of the band
115 cuff
116 exterior surface of the band
118 inner diameter of the band
120 base
125 base flange
130 writing surface
140 weight

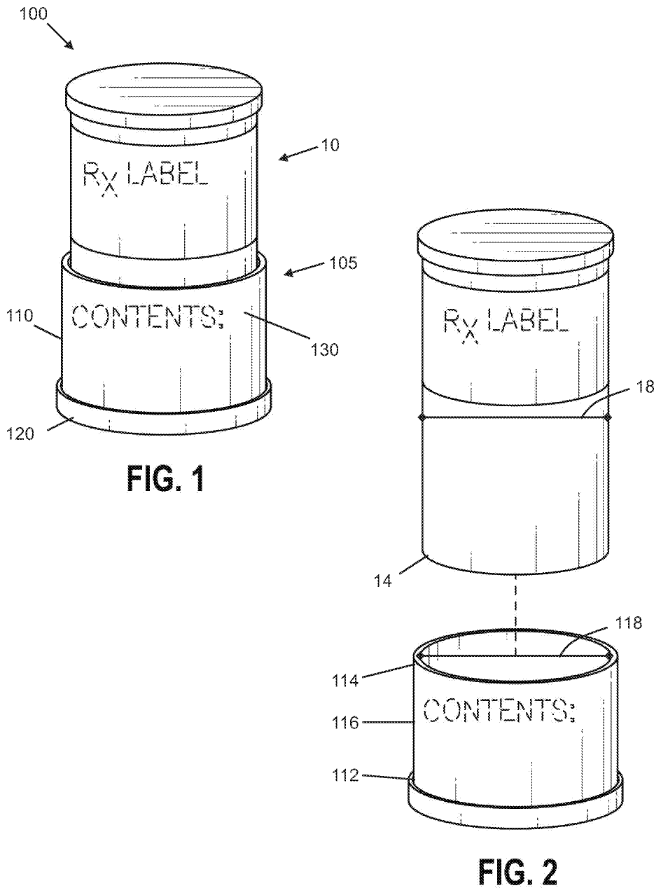

Referring now to FIGS. 1-4H, in one embodiment, the present invention features a non-spill medicine bottle attachment (105) for a medicine bottle (10). The attachment (105) may comprise a band (110) configured to encircle a portion of the medicine bottle, a weighted base (120) disposed on a bottom end (112) of the band, and a writing surface (130) disposed on an exterior surface (116) of the band. In some embodiments, the band (110) can encircle a portion of the medicine bottle, preferably the bottom portion, such that the weighted base (120) is positioned at a bottom end (14) of the medicine bottle. Without wishing to limit the invention to a particular theory or mechanism, the weighted base (120) can stabilize the medicine bottle (10) in an upright standing position, as shown in FIG. 1.

According to another embodiment, the present invention features a system (100) for stabilizing a medicine bottle (10). The system (100) may comprise the medicine bottle (10), and a non-spill medicine bottle attachment (105) comprising a band (110) configured to wrap around a portion of the medicine bottle. In some embodiments, the band (110) may have a stabilizing base (120) disposed on a bottom end (112) of the band, and a writing surface (130) disposed on an exterior surface (116) of the band. In one embodiment, the attachment (105) may be attached to the medicine bottle (10) by placing the band (110) around a portion of the medicine bottle such that the band (110) encircles or wraps around said portion and the base (120) is positioned at a bottom end (14) of the medicine bottle, thereby stabilizing the medicine bottle (10) in an upright standing position. In preferred embodiments, the stabilizing base (120) may be wider than a top end (114) of the band. In other words, the stabilizing base (120) may have a larger diameter than a diameter of the top end (114) of the band.

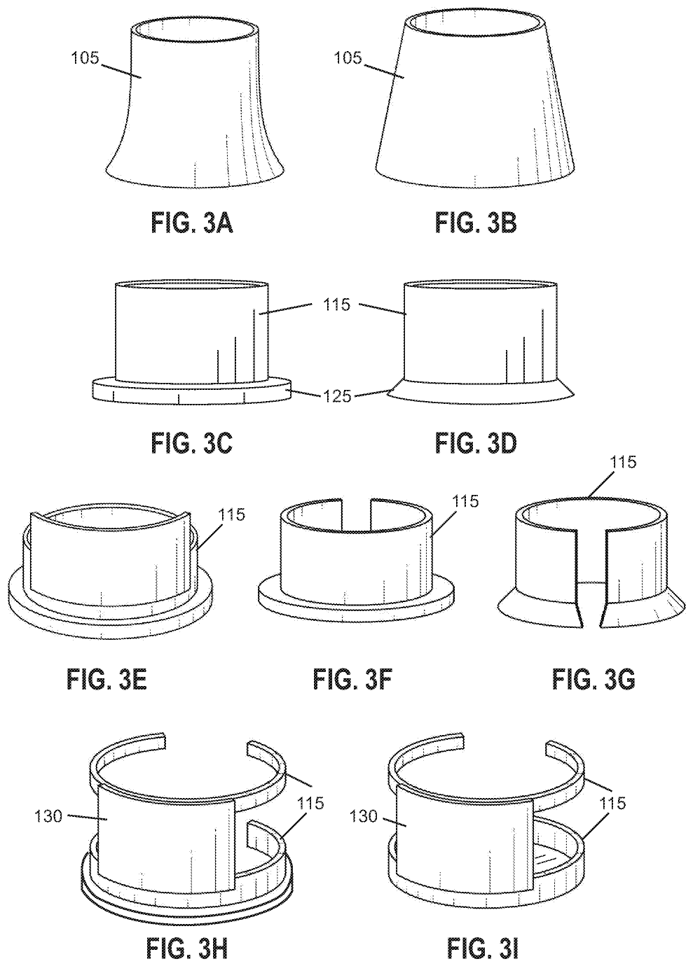

In some embodiments, the band (110) may comprise a circular or tubular cuff (115), such as those shown in FIGS. 3A-3E. In other embodiments, the band (110) may comprise a C-shaped cuff (115), as shown in FIGS. 3F-3H. In still other embodiments, the band (110) may comprise a combination of circular and C-shaped cuffs, as shown in FIG. 3I. As such, the band (110) may comprise one or more cuffs (115). For example, the band (110) may have 1, 2, or 3 cuffs, but is not limited to these examples.

In one embodiment, the bottom end (112) of the band may be wider than a top end (114) of the band. Referring to FIGS. 3A-3B, the band (110) may taper from the bottom end (112) to the top end (114). In another embodiment, the base (120) may be wider than a top end (114) of the band. In some embodiments, as shown in FIGS. 3C-3H, the base (120) may comprise a flange (125) outwardly projecting from the bottom end (114) of the band. As used herein, a flange is a rim or lip projecting from the bottom end (114) of the band in a direction perpendicular to a side wall of the medicine bottle. The flange may be flat like in FIG. 3C, or angled like in FIG. 3D. Without wishing to limit the present invention, it is believed that flange (125) can add weight to the base to stabilize the medicine bottle (10). Furthermore, the flange (125) may provide additional surface area to contact a surface upon which the attachment is placed, such as a counter, shelf, or tabletop.

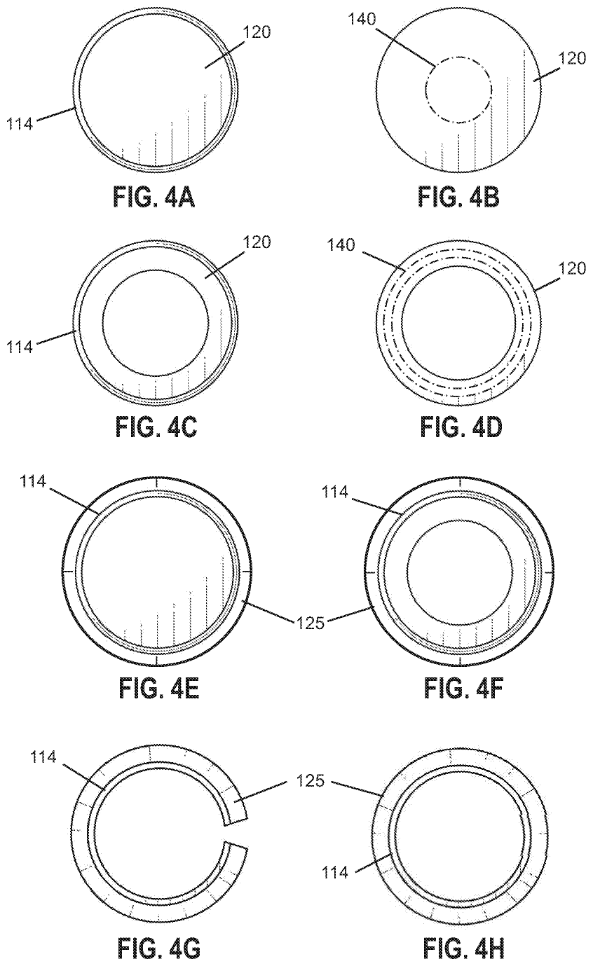

As an alternative or in conjunction, the base (120) may include a weight (140). As shown in FIGS. 4B and 4D, the weight (140) may be disposed within the base at the center or near the periphery of the base. The weight (140) is not limited to a single weight. In some embodiments, the weight (140) may be comprised of a plurality of weights distributed within the base so as to be balanced. In other embodiments, the weight (140) may be comprised of sand, beads, or other particles.

According to one embodiment, the attachment (105) can snap onto the medicine bottle (10). Preferably, the attachment (105) is fitted snugly to the medicine bottle (10) such that the attachment (105) does not slip or fall away from the medicine bottle (10). For example, when the medicine bottle (10) is lifted by its lid or top portion, the attachment (105) remains connected to the medicine bottle (10). In one embodiment, the band (110) may have an inner diameter (118) that is about equal to or slightly larger than an outer diameter (18) of the medicine bottle, thereby allowing for the medicine bottle (10) to slip into the band (110) and the band (110) can snugly fit around the medicine bottle (10). In another embodiment, the attachment (105) is constructed from an elastic material that snugly fits around the medicine bottle (10). For example, the band (110) may be constructed from silicon to form a silicon sleeve that can stretch and wrap around the medicine bottle. In other embodiments, the attachment (105) may be constructed from a plastic, preferably a hard yet flexible plastic.

In preferred embodiments, the band (110) may be adjustable in size to accommodate various sizes of medicine bottles (10). This can be accomplished by the material of construction that allows for the band to stretch. Alternatively or in conjunction, the band (110) may comprise the C-shaped cuff that can expand in diameter due to the opening in its C-shape. For example, the bottle may be pushed through the opening of the C-shaped band such that the band snaps around the bottle. In some embodiments, the attachment may adjustable such that it may be used with any medicine bottle having diameters ranging from about ¾ inch to about 2 inches. In other embodiments, the attachment may be used with medicine bottles having diameters greater than 2 inches.

In preferred embodiments, the writing surface (130) can be written upon to include medical information and label the medicine bottle (10). This allows for the contents of the medicine bottle to be clearly labeled. The label can include the purpose of the medication, e.g. blood pressure, heart, diabetes, cholesterol, etc, the dosage to take, and how often to take the medication. This information may be written in a language most understood by the user, such as English, Spanish, Chinese, Hindi, French, German, Arabic, etc., so that it may be easier for the user to identify the medicine bottle, thereby reducing the risk of selecting the wrong medication.

As used herein, the term “about” refers to ±10% of the referenced number.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Reference numbers recited in the claims are exemplary and are solely for ease of review by the patent office only, and are not limiting in any way. The reference numbers are not intended in any way to limit the scope of the claims to the particular features having the corresponding reference numbers in the drawings. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

What is claimed is:

1. A non-spill medicine bottle attachment (105) for a medicine bottle (10), comprising:
a. a band (110) configured to encircle a portion of the medicine bottle;
b. a weighted base (120) disposed on a bottom end (112) of the band; and
c. a writing surface (130) disposed on an exterior surface (116) of the band.
wherein the band (110) encircles a portion of the medicine bottle such that the weighted base (120) is positioned at a bottom end (14) of the medicine bottle, wherein the weighted base (120) stabilizes the medicine bottle (10) in an upright standing position.

2. The attachment (105) of claim 1, wherein the band (110) comprises a circular or C-shaped cuff (115).

3. The attachment (105) of claim 2, wherein the band (110) comprises one or more cuffs (115).

4. The attachment (105) of claim 1, wherein the bottom end (112) of the band is wider than a top end (114) of the band.

5. The attachment (105) of claim 5, wherein the band (110) tapers from the bottom end (112) to the top end (114).

6. The attachment (105) of claim 1, wherein the base (120) is wider than a top end (114) of the band.

7. The attachment (105) of claim 6, wherein the base (120) comprises a flange (125) outwardly projecting from the bottom end (114) of the band.

8. The attachment (105) of claim 7, wherein the flange (125) adds weight to the base to stabilize the medicine bottle (10).

9. The attachment (105) of claim 1, wherein the base (120) has a weight (140).

10. The attachment (105) of claim 1, wherein the attachment (105) snaps onto the medicine bottle (10).

11. The attachment (105) of claim 1, wherein the band (110) has an inner diameter (118) that is about equal to an outer diameter (18) of the medicine bottle, thereby allowing for the band (110) to snugly fit around the medicine bottle (10).

12. The attachment (105) of claim 1, wherein the band (110) is adjustable in size to accommodate various sizes of medicine bottles (10).

13. The attachment (105) of claim 1, wherein the attachment (105) is constructed from a plastic.

14. The attachment (105) of claim 1, wherein the attachment (105) is constructed from a silicon that snugly fits around the medicine bottle (10).

15. The attachment (105) of claim 1, wherein the writing surface (130) can be written upon to include medical information and label the medicine bottle (10).

16. A system (100) for stabilizing a medicine bottle (10), comprising:
a. the medicine bottle (10); and
b. a non-spill medicine bottle attachment (105) comprising a band (110) configured to wrap around a portion of the medicine bottle, said band (110) having a stabilizing base (120) disposed on a bottom end (112) of the band, and a writing surface (130) disposed on an exterior surface (116) of the band, wherein the stabilizing base (120) is wider than a top end (114) of the band;
wherein the band (110) encircles a portion of the medicine bottle such that the base (120) is positioned at a bottom end (14) of the medicine bottle, wherein the base (120) stabilizes the medicine bottle (10) in an upright standing position.

17. The system (100) of claim 16, wherein the stabilizing base (120) comprises a flange (125) outwardly projecting from the bottom end (114) of the band, wherein the flange (125) adds weight to the base to stabilize the medicine bottle (10).

18. The system (100) of claim 16, wherein the band (110) tapers from the bottom end (112) to the top end (114).

19. The system (100) of claim 16, wherein the band (110) comprises a circular or C-shaped cuff.

20. The system (100) of claim 16, wherein the band (110) is adjustable in size to accommodate various sizes of medicine bottles (10).
